(19) United States
(12) Patent Application Publication
(10) Pub. No.: US 2011/0176134 A1
(43) Pub. Date: Jul. 21, 2011

(54) Method and Apparatus for Null-Measurement of Optical Absorption Using Pulse Width Modulation

(76) Inventors: David A. Rusak, Dalton, PA (US); E. Brady Trexler, Hasbrouck Heights, NJ (US); Ernest A. Kawka, Honesdale, PA (US)

(21) Appl. No.: 13/007,962

(22) Filed: Jan. 17, 2011

Related U.S. Application Data
(60) Provisional application No. 61/336,068, filed on Jan. 15, 2010.
(60) Provisional application No. 61/337,068, filed on Jan. 29, 2010.

(51) Int. Cl. G01N 21/17

(52) U.S. Cl. 356/433

(57) ABSTRACT

Presented is an apparatus for measurement of optical absorption including a calibration method. In addition to providing stand alone measurement of optical absorption, various embodiments of the device also provide for easy integration with medical, clinical, and in-field spectroscopic needs.

### CROSS-REFERENCE TO RELATED APPLICATIONS

This application claims the benefit of the filing date of U.S. Provisional Application Ser. No. 61/337,068, filed on Jan. 29, 2010, under 35 U.S.C. §119(e). The disclosure in that application is incorporated by reference herein.

### FIELD OF THE INVENTION

The present disclosure relates to apparatus and methods of using such apparatus to measure an optical absorption.

### BACKGROUND OF THE INVENTION

The use of light-emitting diodes (LEDs) as light sources in spectroscopic applications is complicated by the fact that LEDs are not monochromatic; they produce a range of wavelengths, known as a spectral bandpass, that is typically 20-30 nm wide. In contrast, a deuterium or tungsten filament lamp in conjunction with a diffraction grating can produce a spectral bandpass of less than 1 nm. These narrow bandpasses are well suited for spectroscopic applications. However, LEDs have an inherent advantage over the lamps in that the intensity of the radiation produced by LEDs can be very precisely controlled. The present invention describes a method and an apparatus for using LEDs as radiation sources in a spectroscopic application that takes advantage of the ability to precisely control the intensity of radiation emitted from an LED. Specifically, it explains the measurement of molecular absorption using a LED-based device and a novel calibration technique. The present invention offers a practical solution to measurement problems commonly encountered in medicine, clinical laboratories, and scientific research.

Molecular absorption is the absorption of electromagnetic radiation by molecules which subsequently undergo an electronic transition in which an electron in the molecule is promoted from a low lying energy level to a higher energy level. As such, a prerequisite for molecular absorption is that the frequency of electromagnetic radiation to be absorbed must match the frequency difference between the two molecular energy levels involved. When this condition is satisfied, the energy from the radiation is absorbed and the electron moves from lower to higher energy. Because all molecules have unique energy level structures, the specific frequencies absorbed by molecules offer the possibility of molecular identification—they become, in essence, a molecular fingerprint.

In addition, the measurement of the amount of radiation absorbed by the molecules is related to the number of molecules in the optical path. Thus, not only can molecules be identified, but they can also be quantified using this technique. The equation that describes the relationship between the amount of radiation absorbed and the concentration of the molecules absorbing is known as Beer's law and given by:

A=−log T=−log Iₒ/Iᵢ=ebc

Where A is the unitless quantity known as absorbance, T is the fraction of radiation that passes through the sample, and Iₒ/Iᵢ represents this same fraction expressed as the intensity of radiation that exits the sample (Iₒ) divided by the intensity of radiation that enters the sample (Iᵢ). This same quantity can be related to the concentration, c (number of molecules per unit volume), by the length of the path the radiation through the sample being analyzed, b, and the inherent absorption of the molecule at the chosen radiation energy, e. A table of some of the most common molecules (analytes) quantified by this technique is shown below. Here the analyte column gives the identity of the molecule to be detected, the method column indicates the basic chemistry, and the wavelength column specifies the specific energy of radiation employed.

| Analyte | Method | Wavelength (nm) |
|---|---|---|
| Bilirubin | Evelyn-Molloy | 555 |
| Cholesterol | Cholesterol oxidase - kinetic | 500 |
| Hemoglobin | CN⁻ + Fe(CN)₆³⁻ | 546 |
| Proteins | Bradford | 595 |
| | Colloidal gold | 595 |
| | Biuret | 550 |
| | BCA | 562 |
| Nucleic acids | 260/280 | 260/280 |

Typical molecular absorption instruments employ a white light source and a diffraction grating which, together, allow selection of a particular wavelength of radiation to be used in measurement. The measurement is made by allowing the radiation to pass through a sample and determining the fraction of the radiation that is transmitted. This transmittance is expressed as the ratio of the intensity of the radiation that comes out of the sample relative to the intensity of the radiation that went into the sample. Commonly, the transmittance (T) is converted to absorption (A) by A=−log T. Traditionally, instruments achieve this measurement by relying on detectors of radiation intensity that are linear in scale, typically photodiodes or photomultipliers. These detectors suffer from poor precision at very low light levels (high absorption) due to dark current. They also suffer from poor precision at high light levels (low absorption) due to shot noise. Thus, the precision of the UV-Vis technique is historically poor at low and high absorption because of sources of noise at low and high radiation intensity.

The object of this invention is to take advantage of the ability to control precisely the intensity of radiation emitted from an LED, or similar radiation source, in order to increase the precision obtainable in a molecular absorption experiment. To accomplish this, an instrument and method that adjusts the intensity of the light source depending on the absorbance of the sample to maintain an intensity of light at the detector that can be measured with high precision. The noise sources in this technique are different than those in the traditional experiment described above.

Many radiation sources, including light-emitting diodes and laser diodes, can be turned on and off very quickly. Because of this, the intensity of light they produce can be precisely controlled by several techniques including pulse-width modulation. In pulse width modulation, the duty cycle of a digital signal is used to produce a variable average output. In our invention, this duty cycle offers one way to control the average intensity of the radiation source. Another technique for controlling intensity of the LED is by controlling the electrical current that flows through the device, although this technique suffers from changes in the wavelengths of radiation emitted at different electrical currents so that changes in intensity are accompanied by changes in the spectrum of the emitted radiation. A third technique for controlling LED intensity is the use of filters of varying optical density to change the intensity of radiation without changing the spectral characteristics. This technique has another advantage in that it can be employed with light sources that are not able to be pulse width modulated. For example, the intensity of light emitted from a filament lamp can be effectively precisely controlled by the use of an variable filter and be employed as a radiation source using the present method of measurement. When the intensity of the light source can be precisely controlled, the necessity of a linear detector for measurement of absorption no longer exists. The requirement for linearity is shifted from the detector to the source.

The present apparatus consists of a radiation source whose emission spectrum relatively matches the absorption spectrum of a molecule in the chosen solution positioned to direct radiation through a transparent holder onto a detector, a sample holder consisting of a transparent cuvette that can hold liquid and a way to reproducibly position it between the source and detector, a detector circuit able to produce a voltage indicative of the integrated (average) intensity of the radiation source, and a control circuit able to store a voltage for a measurement and alter the duty cycle of the radiation source to achieve the same voltage on subsequent measurements. Calculation of the log of the ratio of said duty cycles provides an absorbance (A) proportional to the concentration of an analyte as described by A=ebc, where e is a measure of inherent absorbance at a given wavelength, b is the width of sample holder (pathlength), and c is the concentration of the absorber in the solution as described above.

### LIST OF FIGURES

FIG. 1 is a schematic view of the method of measurement according to one embodiment of the device using a predetermined duty cycle to obtain an initial measurement.

FIG. 1A is a schematic view of the method of measurement according to one embodiment of the device using a pulse width modulated duty cycle to obtain a null measurement.

FIG. 2 is a circuit view of the apparatus according to one embodiment of the device using pulse width modulated light emitting diodes.

FIG. 3 is a circuit view of the apparatus according to one embodiment of the device using a filter and a radiation source.

FIG. 4 is a data set according to one embodiment of the device compared to traditional spectroscopic measurements.

### DETAILED DESCRIPTION OF THE INVENTION

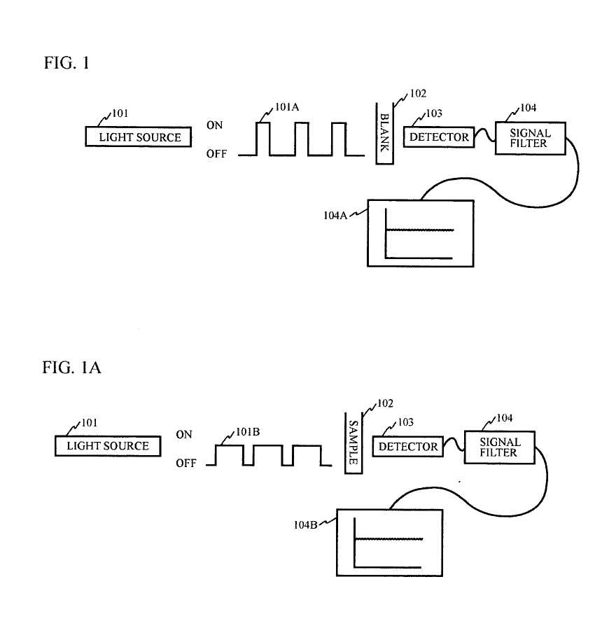

One possible method for measurement of absorption is indicated and described in FIG. 1 and FIG. 1A. First, a light source (101) produces radiation of a specific energy (wavelength) that matches the energy of a transition of a chosen molecule (analyte). This radiation is pulse-width modulated to produce an on-off cycle (duty cycle) so that the resulting radiation is rapidly switched on and off in the form shown (101A). This radiation is directed through a sample holder (102), containing a blank solution none of the analyte onto a detector (103). The signal produced by the detector will naturally be periodic and match the duty cycle of the source. However, a signal filter (104) is used to produce a constant signal proportional to the intensity of radiation incident on the detector. This constant signal (104A) is referred to as the blank signal.

Next, a light source (101) produces radiation of a specific energy (wavelength) that matches the energy of a transition of a chosen molecule (analyte). This radiation is pulse-width modulated to produce an on-off cycle (duty cycle) so that the resulting radiation is rapidly switched on and off in the form shown (101B). This radiation is directed through a sample holder (102), containing the sample solution (analyte), onto a detector (103). The signal produced by the detector will naturally be periodic and match the duty cycle of the source. However, a signal filter (104) consisting of at least a capacitor is used to produce a constant signal proportional to the intensity of radiation incident on the detector. This constant signal (104B) is referred to as the sample signal. The duty cycle of the radiation is now increased (longer on, shorter off) until the sample signal (104B) is identical to the blank signal (104A). When this condition is met the ratio of the duty cycles for the blank and sample is equal to the absorbance (A) The relationship can be expressed as A=log DCₛₐₘₚₗₑ/DC_{blank}

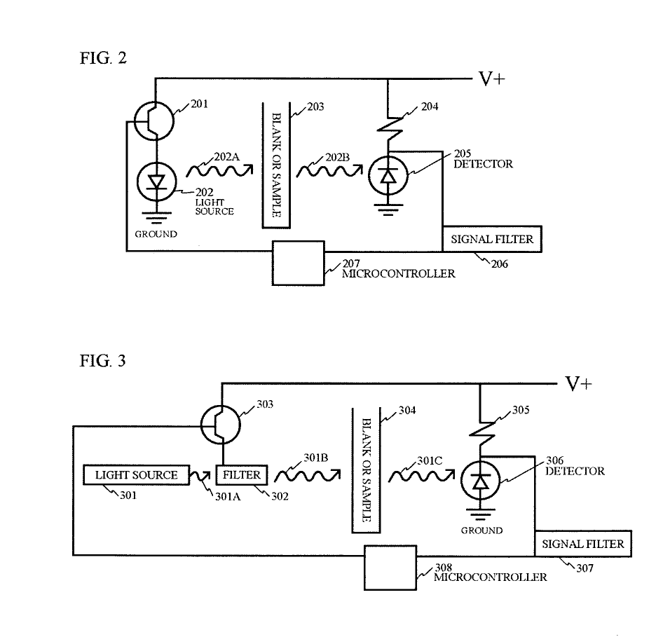

In this embodiment, it is imperative that the detector produce a voltage which is proportional to the average intensity of the light incident upon it. A prerequisite therefore is that the rise and fall times of the detection circuit be identical and independent of the duty cycle of the LED. Much care has been taken in designing a circuit that meets this prerequisite. The circuit, FIG. 2, employs a transistor (201) to gate the current to the LED (202) which produces radiation (202A). The purpose is to ensure that the turn-on and turn-off times are as fast as possible. This radiation passes through the blank or the sample (203) and emerges as radiation with decreased intensity (202B). A resistor (204) and detector (205) act to produce a signal proportional to the intensity of radiation incident on the detector. This signal will naturally be periodic and match the duty cycle of the source. However, a signal filter (206) consisting of at least a capacitor is used to produce a constant signal proportional to the intensity of radiation incident on the detector. This constant signal undergoes analog-to-digital conversion by a microcontroller (207) which also serves to control the intensity of the radiation source.

Another technique allows the microcontroller (207) to store values for voltage that correspond to the precisely controlled intensity of the LED with a blank inserted and compare the voltage obtained when a sample is inserted to determine the fraction of light being absorbed.

Yet another technique, is described in FIG. 3. First, a light source (301) produces radiation of a specific energy (wavelength) that matches the energy of a transition of a chosen molecule (analyte). This radiation (301A) is filtered by a variable filter (302) controlled by a microcontroller (308) and a transistor (303) to produce radiation of a different intensity (301B) This radiation is directed through a blank or sample solution (304) and emerges as radiation with decreased intensity (301C). A resistor (305) and detector (306) act to produce a signal proportional to the intensity of radiation incident on the detector. This signal will naturally be periodic and match the duty cycle of the source. However, a signal filter (307) consisting of at least a capacitor is used to produce a constant signal proportional to the intensity of radiation. Again matching of the signal acquired with the sample to that of the blank yields absorbance by A=log DCₛₐₘₚₗₑ/DC_{blank}.

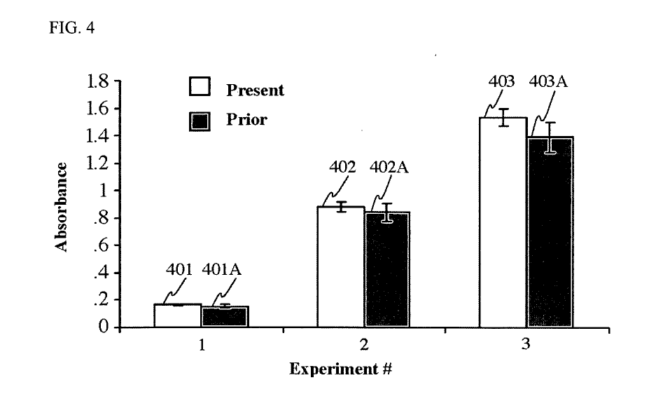

Using the method described in FIGS. 1 and 1A and the technique described in FIG. 2 measurements of optical absorption have been made and compared to traditional measurements. While accuracy is impossible to compare until a large inter-laboratory study can be made or certified standards can be acquired and analyzed by both techniques, precision can be assessed through comparison of standard deviations. FIG. 4 indicates that the measurements made using the apparatus and method described are superior in terms of precision at all absorbance values measured compared to prior art (Beckman D U 640B, Beckman Coulter Inc., Fullerton, Calif.) at a wavelength of 595 nm. The error bars (401) represent the standard deviation of present invention at an average absorbance value of 0.16. The error bars (401A) represent the standard deviation of prior art at an average absorbance value of 0.16. The error bars (402) represent the standard deviation of present invention at an average absorbance value of 0.86. The error bars (402A) represent the standard deviation of prior art at an average absorbance value of 0.86. The error bars (403) represent the standard deviation of present invention at an average absorbance value of 1.44. The error bars (403A) represent the standard deviation of present invention at an average absorbance value of 1.44.

What is claimed is:

1. A method of measuring optical absorption comprising:
illuminating a blank solution with electromagnetic radiation, wherein the electromagnetic radiation is at a predetermined duty cycle;
detecting the electromagnetic radiation after interaction with the blank solution at a detector, wherein the detector produces a blank signal;
illuminating a sample solution with the electromagnetic radiation, wherein the electromagnetic radiation is intensified by increasing duty cycle;
detecting the electromagnetic radiation after interaction with the sample solution at the detector, wherein the detector produces a sample signal, the sample signal is characteristic of a duty cycle capable of producing the sample signal equal to the blank signal; and
calculating an optical absorption A, where A=log I/I₀, where I=duty cycle of the electromagnetic radiation producing the sample signal, and I₀=predetermined duty cycle of the electromagnetic radiation producing the blank signal.

2. The method of claim 1, further comprising:
controlling the duty cycle with an integrated circuit, wherein the integrated circuit is operatively connected to the electromagnetic radiation source and the detector;
detecting the blank signal and the sample signal with the detector, wherein the detector is selected from a group consisting of linear and non-linear; and
providing the blank signal and the sample signal from the detector to the integrated circuit, wherein the integrated circuit calculates the optical absorbance.

3. The method of claim 1, further comprising:
illuminating a sample solution with the electromagnetic radiation, the electromagnetic radiation is filtered by an electromagnetic radiation filter, wherein the electromagnetic radiation is intensified by increasing electromagnetic radiation filter duty cycle; and
controlling the electromagnetic radiation filter duty cycle with an integrated circuit, wherein the integrated circuit is operatively connected to the electromagnetic radiation filter and the detector.

4. The method of claim 1, wherein the calculating an optical absorbance is measured by matching a blank signal voltage with a sample signal voltage, wherein the electromagnetic radiation being absorbed is the optical absorbance.

5. An optical absorption apparatus comprising:
an electromagnetic radiation source focused to illuminate electromagnetic radiation onto a sample holder, wherein the electromagnetic radiation interacts with a sample in the sample holder;
a detector positioned to detect the radiation after interaction with the sample; and
an integrated circuit operatively connected to the radiation source and the detector, wherein the integrated circuit operatively controls intensity of the electromagnetic radiation, wherein the detector produces a sample signal, the sample signal is characteristic of a duty cycle capable of producing the sample signal equal to a blank signal.

6. The optical absorption apparatus of claim 5, further comprising an electromagnetic radiation filter positioned between the sample holder and the electromagnetic radiation source, wherein the electromagnetic radiation is intensified by increasing electromagnetic radiation filter duty cycle, the integrated circuit is operatively connected to the electromagnetic radiation filter.
